(19) United States
(12) Patent Application Publication
(10) Pub. No.: US 2015/0277194 A1
(43) Pub. Date: Oct. 1, 2015

(54) LIQUID CRYSTAL DISPLAY DEVICE

(71) Applicant: Sharp Kabushiki Kaisha, Osaka-shi (JP)

(72) Inventors: Kaori Saitoh, Osaka-shi (JP); Yasuyoshi Kaise, Osaka-shi (JP)

(73) Assignee: Sharp Kabushiki Kaisha, Osaka-shi (JP)

(21) Appl. No.: 14/432,831

(22) PCT Filed: Sep. 30, 2013
(86) PCT No.: PCT/JP2013/076532

§ 371 Date: Apr. 1, 2015

(30) Foreign Application Priority Data
Oct. 3, 2012 (JP) 2012-221750

(51) Int. Cl. G02F 1/1343; G02F 1/1339; G02F 1/1337; G02F 1/1362

(52) U.S. Cl. CPC G02F 1/134363; G02F 1/136286; G02F 1/13394; G02F 1/133784; G02F 1/13439; G02F 2001/134345

(57) ABSTRACT

First subpixel group and second subpixel group are disposed alternately in a direction orthogonal to a gate bus line. A first subpixel and a second subpixel have shapes axially symmetric about a symmetry axis. Each of a plurality of first subpixels includes a plurality of first strip electrodes inclined by an angle of α clockwise with respect to a rubbing direction. Each of a plurality of second subpixels includes a plurality of second strip electrodes inclined by an angle of α counterclockwise with respect to a rubbing direction. Each of a plurality of source bus lines includes a first inclined part inclined by an angle of β clockwise with respect to a rubbing direction and a second inclined part inclined by an angle of β counterclockwise with respect to a rubbing direction. A rubbing direction is orthogonal to a gate bus line. Each of a plurality of spacers is disposed in a vicinity of a source bus line and also disposed linearly in parallel with a rubbing direction.

### TECHNICAL FIELD

The present invention relates to a liquid crystal display device.

The subject application claims priority based on the patent application No. 2012-221750 filed in Japan on Oct. 3, 2012 and incorporates by reference herein the content thereof.

### BACKGROUND ART

Conventionally, in a liquid crystal display device, a lateral electric field type in which an electric field is applied to a liquid crystal layer has been known. In a lateral electric field type of liquid crystal display device, common and pixel electrodes are provided on one substrate of a pair of substrates sandwiching a liquid crystal layer, and an electric field is applied to the liquid crystal layer in substantially the lateral direction (substantially parallel to the substrate). In this case, because the directors of the liquid crystal molecules stand perpendicularly with respect to the substrate, there has been an advantage of broadening the viewing angle.

Lateral electric field type liquid crystal display devices include, depending upon the configuration of the electrodes, IPS (in-plane switching) type liquid crystal display devices and FFS (fringe field switching) type liquid crystal display devices. In a lateral electric field type liquid crystal display device, a plurality of strip electrodes are formed within a subpixel, and the orientation of the liquid crystal layer is controlled in the direction of arrangement of the plurality of strip electrodes. In a liquid crystal display device, a multi-domain constitution provided within a pixel has been known, for the purpose of improving the viewing angle. One known method of providing a multi-domain structure is to cause the orientation of the strip electrodes to be different between mutually neighboring subpixels.

In a liquid crystal display device, spacers are provided on the surface of the liquid crystal layer side of the substrate that separates the pair of substrates by a prescribed spacing (gap). Columnar spacers such as described in Patent Reference 1 have been known as spacers such as this. The columnar spacers of Patent Reference 1 are formed directly on the substrate, using resist or the like. An orientation film is formed over a substrate onto which the columnar spacers have been formed over each of the opposing substrate surfaces, and rubbing processing has been performed thereof. PRIOR ART DOCUMENT

### Patent Document

[Patent Document 1] Japanese Unexamined Patent Application, First Publication No. 2007-232820

### SUMMARY OF THE INVENTION

Problem to Be Solved by the Invention

Because the columnar spacers of Patent Reference 1 are performed before rubbing, poor rubbing might result on the downstream side of the rubbing direction of the columnar spacers when rubbing processing is done. For this reason, the density of the columnar spacers in Patent Reference 1 is made small to suppress the occurrence of poor orientation caused by such poor rubbing.

It happens that, in a liquid crystal display device as in Patent Reference 1, the columnar spacers exist at points having a certain spacing along the long side of a rectangular subpixel. As described above, a method proposed for achieving a multi-domain structure is that of mutually inclining the strip electrodes of two subpixels that are neighboring top/bottom in opposite directions, so that the shapes of each of the subpixels is formed in an inclined direction. In a multi-domain structure such as this, if the columnar spacers are disposed along the long side of the subpixels, as described in Patent Reference 1, the columnar spacers are disposed in in a zig-zag manner in the up/down direction. In this case, even if the density of the columnar spacers is made small as in Patent Reference 1, it is not possible to sufficiently suppress the occurrence of poor orientation due to poor rubbing.

The present invention is made to solve the above-noted problem and has as an object to provide a liquid crystal display device capable of suppressing poor orientation caused by spacers.

### Means to Solve the Problem

(1) That is, a liquid crystal display device according to a first aspect of the present invention is a liquid crystal display device in which a plurality of spacers are disposed between a pair of substrates and a liquid crystal is disposed in a gap between the pair of substrate maintained by the plurality of spacers, the liquid crystal display device including: a plurality of source bus lines disposed to be mutually neighboring; a plurality of gate lines disposed to be mutually neighboring and intersecting with the plurality of source lines; a first subpixel group including a plurality of first subpixels, and a second subpixel group including a plurality of second subpixels; wherein the first and second subpixel groups are disposed alternately in a direction orthogonal to the gate bus line, each of the plurality of first subpixels includes a plurality of first strip electrodes including a part inclined by an angle of α (0°<α<90°) clockwise with respect to a rubbing direction, each of the plurality of second subpixels includes a plurality of second strip electrodes including a part inclined by an angle of α (0°<α<90°) counterclockwise with respect to the rubbing direction, each of the plurality of source bus lines includes a first inclined part inclined by an angle of β (0°<β<90°) clockwise with respect to the rubbing direction and also extending along an edge of the first subpixel and a second inclined part inclined by an angle of β (0°<β<90°) counterclockwise with respect to the rubbing direction and also extending along an edge of the second subpixel, the rubbing direction is orthogonal to the gate bus line, and each of the plurality of spacers is disposed in a vicinity of the source bus line and also disposed linearly in parallel with the rubbing direction.

(2) In the liquid crystal display device according to the above-described (1), each of the plurality of spacers may be disposed at a position that overlaps each of the plurality of gate bus lines.

(3) In the liquid crystal display device according to the above-described (1) or (2), each of the plurality of spacers may be disposed at a position that does not overlap a part of intersection between the plurality of source bus lines and gate bus lines.

(4) In the liquid crystal display device according to the above-described (3), the plurality of spacers may include a first spacer group including a plurality of first spacers disposed on one side in a direction parallel to the gate bus line with respect to each of the plurality of source bus lines; and a second spacer group including a plurality of second spacers disposed on another side opposite from the one side with respect to each of the plurality of source bus lines, and wherein the first spacer group and the second spacer group may be disposed alternately in a direction orthogonal to the gate bus line.

(5) In the liquid crystal display device according to the above-described (1) or (2), the plurality of spacers may include a plurality of main spacers that make contact with both of the pair of substrates and a plurality of subspacers that make contact with one of the pair of substrates, and wherein, of the plurality of spacers, at least each of the plurality of subspacers may be disposed linearly in parallel with the rubbing direction.

(6) In the liquid crystal display device according to the above-described (1) or (2), the plurality of spacers may include a third spacer group including a plurality of third spacers disposed at positions overlapping parts of intersection between the plurality of source bus lines and the plurality of gate bus lines and a fourth spacer group including a plurality of fourth spacers disposed at positions not overlapping parts of intersection between the plurality of source bus lines and the plurality of gate bus lines, and wherein the third spacer group and the fourth spacer group may be disposed alternately in a direction orthogonal to the gate bus lines.

(7) In the liquid crystal display device according to the above-described (6), each of the first subpixel group and the second subpixel group may include a plurality of red subpixels and a plurality of blue subpixels disposed to be mutually neighboring, and each of the plurality of fourth spacers may be disposed more toward the blue subpixel side than the boundary part between the red subpixel and the blue subpixel.

(8) In the liquid crystal display device according to any one of the above-described (1) to (7), the first subpixel and the second subpixel may include shapes axially symmetric about a symmetry axis parallel to the gate bus line.

(9) In the liquid crystal display device according to any one of the above-described (1) to (8), at an undriven time, in a case that a drive signal is not supplied to the plurality of first strip electrodes, the orientation direction of the liquid crystal layer may coincide with the rubbing direction, and at a driven time, in a case that a drive signal is supplied to the plurality of first strip electrodes, the orientation direction of the liquid crystal layer may coincide with the direction of arrangement of the plurality of first strip electrodes, and wherein at an undriven time, in a case that a drive signal is not supplied to the plurality of second strip electrodes, the orientation direction of the liquid crystal layer may coincide with the rubbing direction, and at a driven time, in a case that a drive signal is supplied to the plurality of second strip electrodes, the orientation direction of the liquid crystal layer may coincide with the direction of arrangement of the plurality of second strip electrodes.

### Effect of the Invention

According to the present invention, it is possible to provide a liquid crystal display device capable of suppressing poor orientation caused by spacers.

### BRIEF DESCRIPTION OF THE DRAWINGS

FIG. 1 is an exploded oblique view showing the general constitution of a liquid crystal display device according to a first embodiment.

FIG. 2 is a plan view describing the disposition of subpixels and strip electrodes according to the first embodiment.

FIG. 3 is a plan view describing the disposition of the spacers according to the first embodiment.

FIG. 4 is a cross-sectional view of the liquid crystal display device, along the line H-H in FIG. 3.

FIG. 5 is a plan view describing the operating effect of a liquid crystal display device according to a comparison example.

FIG. 6 is a plan view describing the operating effect of the liquid crystal display device according to the first embodiment.

FIG. 7 is a plan view describing the disposition of spacers according to a second embodiment.

FIG. 8 is a cross-sectional view of the liquid crystal display device along the line I-I in FIG. 7.

FIG. 9 is a plan view describing the disposition of spacers according to a third embodiment.

### EMBODIMENT FOR CARRYING OUT THE INVENTION

### First Embodiment

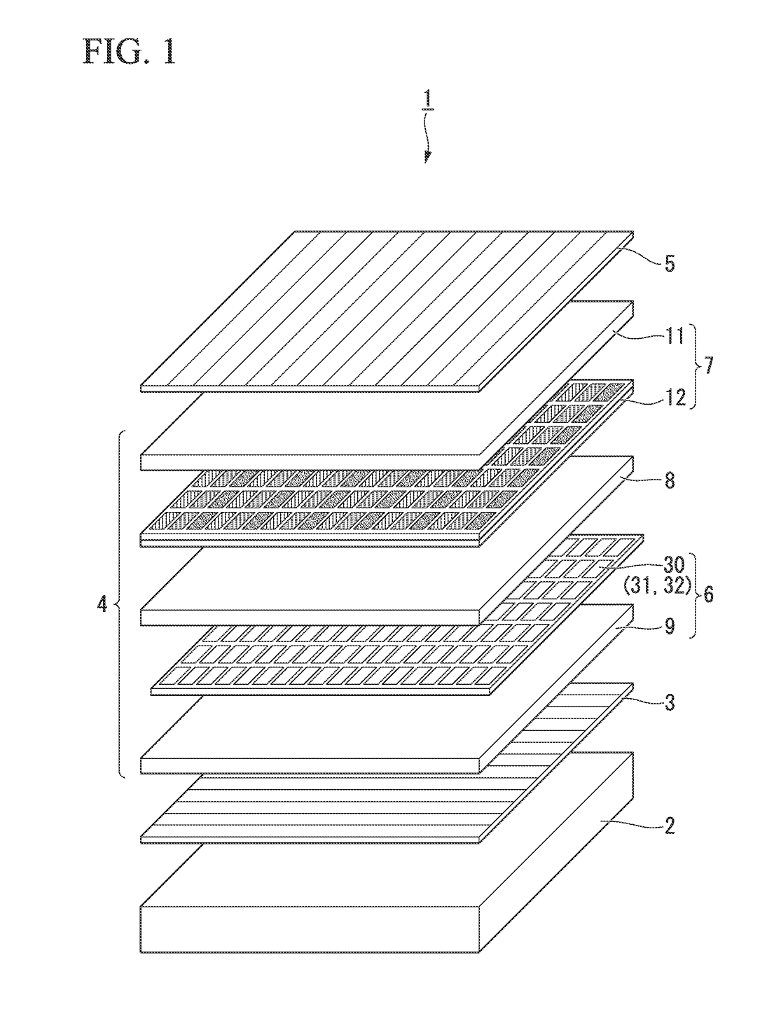

The first embodiment of the present invention will be described below, using FIG. 1 to FIG. 6.

The liquid crystal display of the present embodiment is a lateral electric field type liquid crystal display device having a pair of electrodes on one substrate of a pair of substrates sandwiching a liquid crystal layer, in which an electric field applied between the pair of electrodes drives the liquid crystal. In the present embodiment, an active matrix type liquid crystal display device using fringe field switching will be described as an example.

FIG. 1 is an exploded oblique view showing the general constitution of a liquid crystal display device 1 according to the first embodiment.

In order to make the various constituent elements easy to see in the drawings referenced below, the scale of the dimensions of the constituent elements might be changed.

As shown in FIG. 1, the liquid crystal display device 1 of the present embodiment has, from the rear as seen by an observer, a backlight 2, a polarizing sheet 3, a liquid crystal cell 4, and a polarizing sheet 5. The liquid crystal display device 1 of the present embodiment is a transmission-type liquid crystal display device that makes a display by controlling the transmissivity with respect to the light exiting the backlight 2, using the liquid crystal cell 4.

The liquid crystal cell 4 has a thin-film transistor (hereinafter abbreviated TFT) array substrate 6 and an opposing substrate 7, which are disposed in opposition to one another, and a liquid crystal layer 8 sandwiched between the TFT array substrate 6 and the opposing substrate 7. Although a positive type liquid crystal material is generally used in the liquid crystal layer 8, a negative type liquid crystal material may be used. The TFT array substrate 6 has a plurality of subpixels 30 arranged in a matrix on the substrate 9, the plurality of subpixels 30 constituting a display region (screen). The opposing substrate 7 is provided with a color filter 12 on a substrate 11.

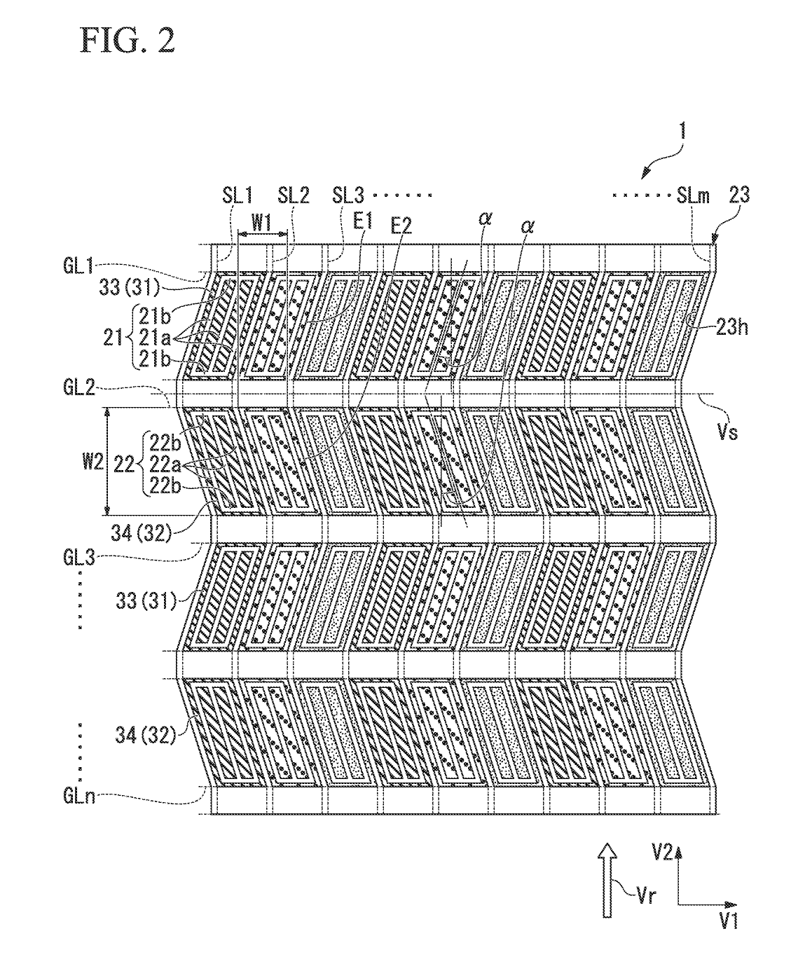

FIG. 2 is a plan view showing a part of the display region of the TFT array substrate 6 seen from the opposing substrate 7 side. FIG. 2 is a plan view describing the disposition between the subpixels and the strip electrodes in the first embodiment.

In FIG. 2, the reference symbol V1 indicates a first direction parallel to one surface of the substrate 11, and the reference symbol V2 indicates a second direction parallel to one surface of the substrate 11 and also orthogonal to the first direction V1. The reference symbol Vs indicates an axis (symmetry axis) parallel to the first direction V1. The reference symbol Vr indicates the rubbing direction for performing rubbing processing with respect to the orientation film. The rubbing direction Vr is a direction orthogonal to the first direction V1 (a direction parallel to the second direction V2).

In FIG. 2, the black matrix 23 of the opposing substrate 7 is illustrated as a convenience.

As shown in FIG. 2, the TFT array substrate 6 is provided with a plurality of source bus lines (SL1 to SLm) disposed to be mutually neighboring in parallel, a plurality of gate bus lines (GL1 to GLn) disposed to be mutually neighboring in parallel and intersecting with the plurality of source bus lines (SL1 to Slm), and a plurality of pixel electrodes.

In the description to follow, the general term source bus line SL might be used for a source bus line, and the general term gate bus line GL might be used for a gate bus line.

Of a source line SL, the part overlapping with a gate bus line GL when seen in plan view is linear and orthogonal with respect to a direction of extension of the gate bus line GL.

Although not illustrated, TFTs are provided in the vicinity of intersection parts at which a source bus line SL intersects with a gate bus line GL.

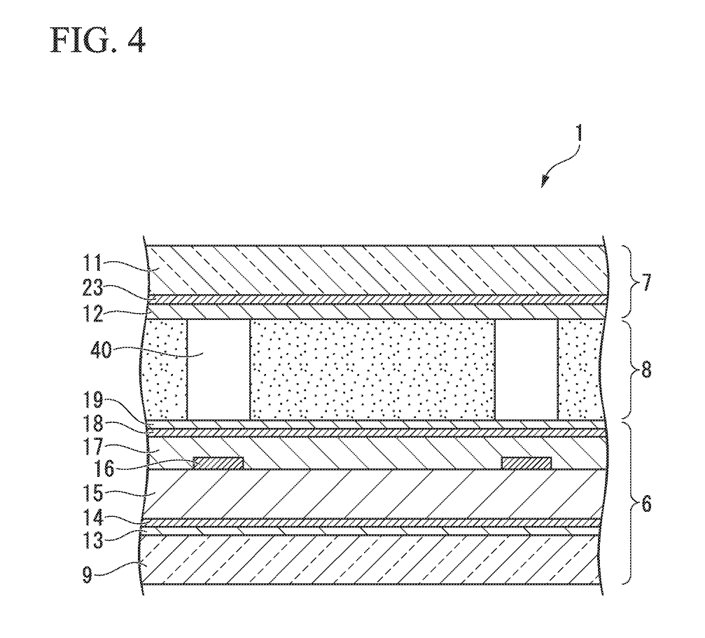

A TFT has a gate electrode 14 electrically connected to a gate bus line GL (refer to FIG. 4), a gate electrode 13, a semiconductor layer disposed under the gate insulating film 13, a source electrode 16 electrically connected to a source bus line SL, and a drain electrode electrically connected to a pixel electrode. The semiconductor layer is, for example, constituted by amorphous silicon, polycrystalline silicon, or an oxide semiconductor (such as InGaZnOx).

The plurality of gate bus lines (GL1 to GLn) are sequentially supplied from a non-illustrated gate driver with scan signals in the sequence GL1, GL2, GL3, . . . , GLn. In response to these scan signals, the TFTs are driven in units of horizontal lines.

The plurality of source bus lines (SL1 to SLm) are supplied from a non-illustrated source driver with pixel signals for one horizontal line for each one horizontal period in which the scan signals are supplied to the gate bus lines GL.

On the TFT array substrate 6, the plurality of source bus lines (SL1 to SLm) and the plurality of gate bus lines (GL1 to GLn) are disposed so as to be mutually intersecting with each other. A region surrounded by two neighboring source bus lines SL and two neighboring gate bus lines is one subpixel.

In the present embodiment, a black matrix 23 is formed in the regions of overlapping between the plurality of source bus lines (SL1 to SLm) and the plurality of gate bus lines (GL1 to GLn).

That is, the shape of the apertures 23h in the black matrix 23 is governed by the shape of the subpixels. The subpixels (first subpixels 31 and second subpixels 32), which are the smallest unit of display, are arranged in a matrix on the TFT array substrate 6.

In this specification, the first subpixels 31 and the second subpixels 32 will sometimes be collectively called subpixels. The width of the source bus lines SL and the width of the gate bus lines GL are each narrower than the width of the black matrix 23.

The size of a subpixel is, for example, a lateral width W1 of approximately 20 μm and a longitudinal width W2 of approximately 60 μm. In this case, the lateral width W1 is the length of the subpixel in the first direction V1, and the vertical width W2 is the length of the subpixel in the second direction V2.

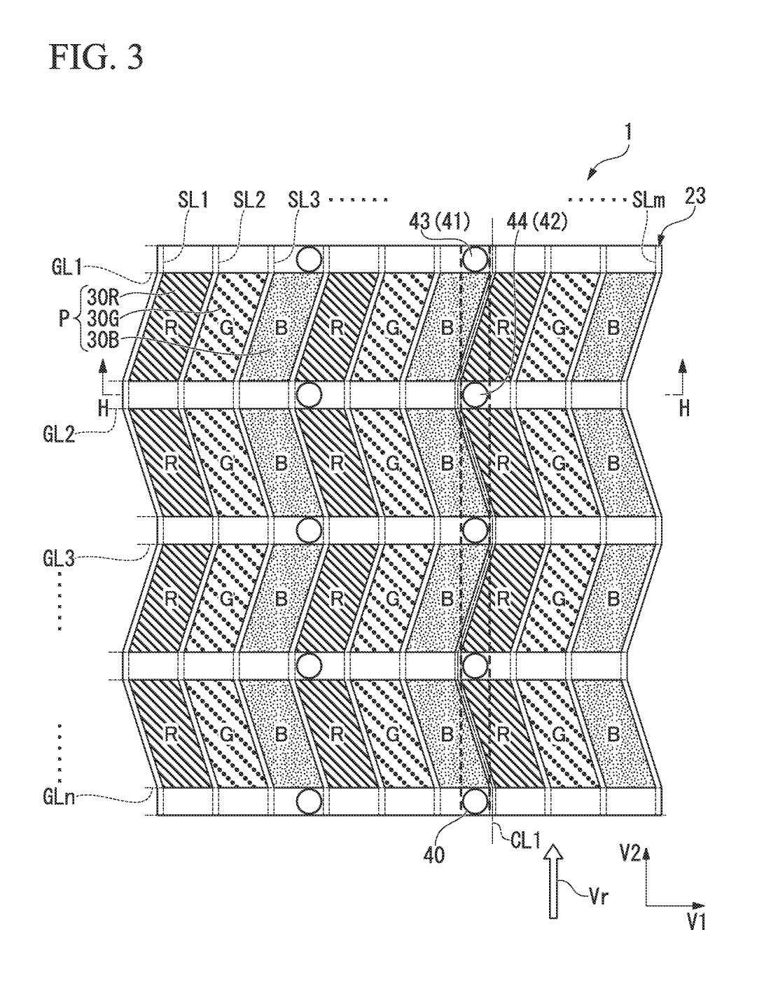

FIG. 3 is a plan view showing the condition in which a plurality of spacers 40 are disposed on the surface of the orientation film on the opposing substrate 7 side. As shown in FIG. 3, in the present embodiment, the three subpixels of the red subpixel 30R that outputs red light, the green subpixel 30G that outputs green light, and the blue subpixel 30B that outputs blue light constitute one pixel P. The red subpixel 30R, the green subpixel 30G, and the blue subpixel 30B are arranged in that sequence along the first direction V1.

Next, referring to FIG. 4, the cross-sectional constitution of the liquid crystal display device 1 will be described.

FIG. 4 is a cross-sectional view of the liquid crystal display device 1 along the line H-H in FIG. 3. In FIG. 4, as a convenience, the backlight 2, the polarizing sheet 3, the polarizing sheet 5, and the orientation film and the like have been omitted.

First, the constitution of the TFT array substrate 6 will be described.

As shown in FIG. 4, the gate insulating film 13 is formed on the substrate 9. A transparent substrate such as a glass substrate can be used as the substrate 9. An inorganic insulating material such as a silicon nitride film, a silicon oxide film, a silicon oxynitride film, or a laminated film thereof can be used as the material for forming the gate insulating film 13.

A gate electrode 14 is formed on the gate insulating film 13. A laminated film of W (tungsten)/TaN (tantalum nitride), or Mo (molybdenum), Ti (titanium), or Al (aluminum) or the like may be used as the material for forming the gate electrode 14. The gate electrode 14 is formed as one part of the gate bus line GL.

An interlayer insulating film 15 is formed on the gate electrode 14. The material for forming the interlayer insulating film 15 can be the same type of inorganic insulating material as noted above regarding the gate insulating film 13.

A source electrode 16 is formed on the interlayer insulating film 15. The material for forming the source electrode 16 can be the same type of semiconductor material as noted above regarding the gate electrode 14.

An organic insulating film 17 is formed on the interlayer insulating film 15 so as to cover the source electrode 16. An organic insulating material such as a polyimide, a polyamide, an acryl, a polyimide-amide, or benzocyclobutene or the like can be used as the material for forming the organic insulating film 17.

A common electrode 18 (opposing electrode) is formed on the organic insulating film 17. A transparent conductive material such as ITO (indium tin oxide), IZO (indium zinc oxide), or the like can be used as the material for forming the common electrode 18.

An insulating film 19 is formed on the common electrode 18. The same type of inorganic insulating material as noted above regarding the gate electrode 13 can be used as the material for forming the insulating film 19.

Although not illustrated, pixel electrodes are formed on the insulating film 19. The same type of transparent conductive material as noted above regarding the common electrode 18 can be used as the material for forming the pixel electrodes. An orientation film is formed on the insulating film 19 so as to cover the pixel electrodes. The orientation film has an orientation controlling force that orients the liquid crystal molecules of the liquid crystal 8 layer horizontally.

Next, the constitution of the opposing substrate 7 will be described.

A transparent substrate such as a glass substrate can be used as the substrate 11. The opposing substrate 7 is a color filter substrate formed on the substrate 11 by the color filter 12 and the black matrix 23. A non-illustrated orientation film is formed on the liquid crystal layer 8 side of the opposing substrate 7.

A plurality of spacers 40 each arranged in parallel to the rubbing direction are disposed between the TFT array substrate 6 and the opposing substrate 7. The spacers 40 are columnar spacers.

Returning to FIG. 2, a first subpixel group 33 formed from a plurality of parallelogram-shaped first subpixels 31 arranged in the first direction V1 and a second subpixel group 34 formed from a plurality of parallelogram-shaped second subpixels 32 arranged in the first direction V1 are arranged alternately in the second direction V2. The first subpixels 31 and the second subpixels 32 have axial symmetry about the symmetry axis Vs.

Each of the plurality of gate bus lines (GL1 to GLn) extends in the first direction V1. Each of the plurality of source bus lines (SL1 to SLm) bend around, respectively, a side E1 of the four sides of the first subpixel 31 that intersects with the first direction V1 and a side E2 of the four sides of the second subpixel 32 that neighbors to the side El of the first subpixel 31.

Stated differently, each of the plurality of gate bus lines (GL1 to GLn) has a first inclined part that is inclined with respect to the rubbing direction Vr by an angle of β (0°<β<90°) and also extends along an edge (side E1) of the first subpixel 31 and a second inclined part that is inclined with respect to the rubbing direction Vr by an angle of β (0°<β<90°) and also extends along an edge (side E2) of the second subpixel 32.

Although it is preferred that the angle β and the angle α be the same angle, they may be angles that differ slightly.

A first pixel electrode 21 is disposed at each of the plurality of first subpixels 31. A second pixel electrode 22 is disposed at each of the plurality of second subpixels 32. In this specification, the first pixel electrode 21 and the second pixel electrode 22 are sometimes referred to collectively as pixel electrodes.

The first pixel electrodes 21 have a plurality of first strip electrodes 21a disposed mutually parallel, with a prescribed spacing therebetween, and a first linking part 21b that links the plurality of first strip electrodes 21a. The plurality of first strip electrodes 21a are integrally linked and electrically connected by two first linking parts 21b provided at the top and bottom of FIG. 2. Each of the plurality of first strip electrodes 21a is inclined with respect to the rubbing direction Vr by an angle of α (0°<α<90°) in the clockwise direction. In the present embodiment, as one example, the first strip electrode 21a is inclined by 10° in the clockwise direction with respect to the rubbing direction Vr. Although the entire of each of the plurality of first strip electrodes 21a is inclined by an angle of α, this is not a restriction, and the first strip electrodes 21a may have a part that is inclined by the angle α.

At an undriven time, when a drive signal is not supplied to the plurality of first strip electrodes 21a, the orientation direction of the liquid crystal layer 8 coincides with the rubbing direction Vr. In contrast, at a driven time, when a drive signal is supplied to the plurality of first strip electrodes, the orientation direction of the liquid crystal layer 8 coincides with the direction of arrangement of the plurality of first strip electrodes 21a (direction orthogonal to the longitudinal direction of the first strip electrodes 21a).

The second pixel electrodes 22 have a plurality of second strip electrodes 22a disposed mutually parallel with a prescribed spacing therebetween and a second linking part 22b that links the plurality of second strip electrodes 22a. The plurality of second strip electrodes 22a are integrally linked and electrically connected by two second linking parts 22b provided at the top and bottom of FIG. 2. Each of the second strip electrodes 22a is inclined with respect to the rubbing direction Vr by an angle of α (0°<α<90°) in the counterclockwise direction. In the present embodiment, as one example, the second strip electrode 22a is inclined by 10° in the counterclockwise direction with respect to the rubbing direction Vr. Although the entire of each of the plurality of second strip electrodes 22a is inclined by an angle of α, this is not a restriction, and the second strip electrodes 22a may have a part that is inclined by the angle α.

At an undriven time, when a drive signal is not supplied to the plurality of second strip electrodes 22a, the orientation direction of the liquid crystal layer 8 coincides with the rubbing direction Vr. In contrast, at a driven time, when a drive signal is supplied to the plurality of second strip electrodes 22a, the orientation direction of the liquid crystal layer 8 coincides with the direction of arrangement of the plurality of second strip electrodes 22a (direction orthogonal to the longitudinal direction of the second strip electrodes 22a).

At an undriven time, when a voltage is not applied between the pixel electrodes 20 and the common electrode 18, the orientation directions of the liquid crystal molecules of each of the first subpixels 31 and second subpixels 32 have axial symmetry about the symmetry axis Vs. At a driven time, when a voltage is applied between the pixel electrodes 20 and the common electrode 18, the rotation direction of the liquid crystal molecules in each of the first subpixels 31 and second subpixels 32 has axial symmetry with respect to the symmetry axis Vs. That is, in the liquid crystal display device 1, the direction of rotation of the liquid crystal molecules between the driven time and a non-driven time has axial symmetry with respect to direction perpendicular to the symmetry axis Vs. In an embodiment such as this, using two neighboring subpixels about the symmetry axis Vs, pixels have a dual-domain structure.

FIG. 3 is a plan view describing the disposition of the spacers 40 according to the first embodiment.

In FIG. 3, the reference symbol CL1 indicates the center line of the source bus line SL. The reference symbol CL1 can be said to indicate the center line of the part of the black matrix 23 that overlaps with the source bus line SL.

As shown in FIG. 3, each of the plurality of spacers 40 is disposed in the vicinity of the source bus line SL and also disposed linearly in parallel with the rubbing direction Vr. In the present embodiment, the center of each of the spacers 40 is disposed along a straight line.

However, if two spacers disposed at neighboring positions along the source bus line SL are SP1 and SP2, the distance J between SP1 and SP2 in a direction along the gate bus line GL must be smaller than K cos γ (J<K cos γ).

In this case, if we let the length of an edge of a subpixel (side E1 or E2) be K and the angle of inclination of the edge of the subpixel be γ (90°−β), it is most desirable that the center of each of the spacers 40 be disposed along a straight line.

Disposal along a straight line includes, when two spacers disposed at neighboring positions along the source bus line SL are SP1 and SP2, the condition in which the distance J between SP1 and SP2 in a direction along the gate bus line GL is smaller than K cos γ.

Each of the spacers 40 is disposed at a position overlapping with the plurality of gate bus lines (GL1 to GLn). Each of the spacers 40 is disposed within the region in which the black matrix is formed. A spacer 40 is circular when seen in plan view, and has a diameter of approximately 12 μm. The spacers 40 can have various shapes, such as rectangular, when seen in plan view.

Each of the plurality of spacers 40 is disposed at a position that does not overlap with the parts of intersection between the plurality of source bus lines (SL1 to SLm) and the plurality of gate bus line (GL1 to GLm).

The plurality of spacers 40 have a first spacer group 43 formed by a plurality of first spacers 41 disposed on one side (the left side; blue subpixel 30B side) in the first direction V1 with respect to each of the plurality of source bus lines (SL1 to SLm) and a second spacer group 44 formed by a plurality of second spacers 42 disposed on the opposite other side (the right side; red subpixel 30R side) with respect to each of the plurality of source bus lines (SL1 to SLm).

In this case, “first direction V1 with respect to each of the plurality of source bus lines (SL1 to SLm)” means “first direction V1 with respect to the center line CL1 of each of the plurality of source bus lines (SL1 to SLm).” The “opposite other side with respect to each of the plurality of source bus lines (SL1 to SLm)” means “opposite other side with respect to the center line CL1 of each of the plurality of source bus lines (SL1 to SLm).” This will apply as well to the description to follow.

In the present embodiment, the first spacer group 43 and the second spacer group 44 are disposed alternately in the second direction V2. This creates a constitution in which the plurality of spacers 40 are disposed linearly (the broken line parts of FIG. 3) in parallel with the rubbing direction Vr.

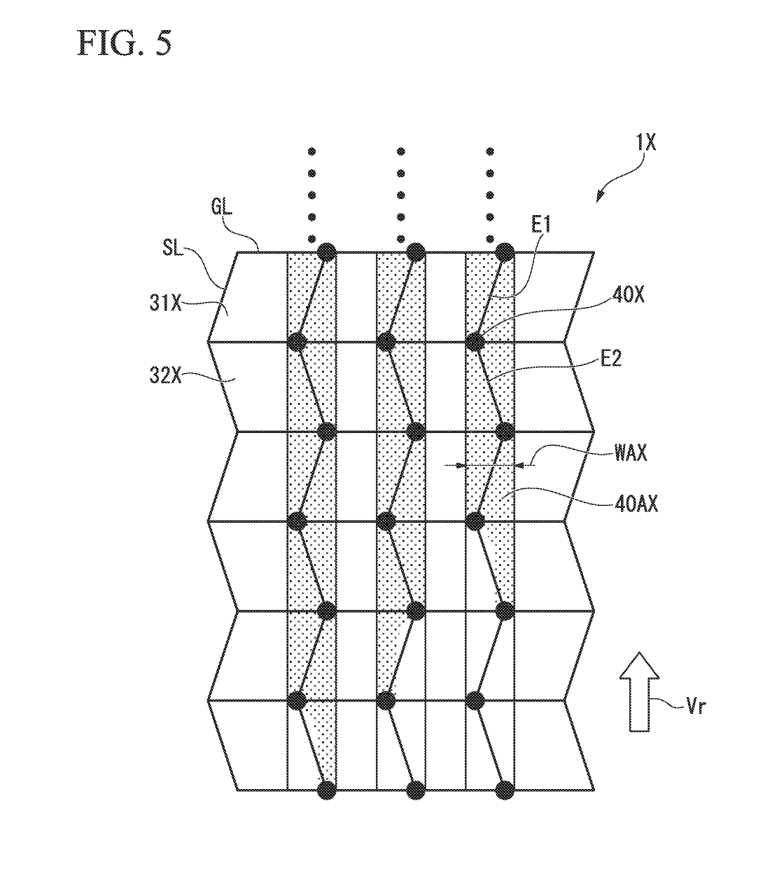

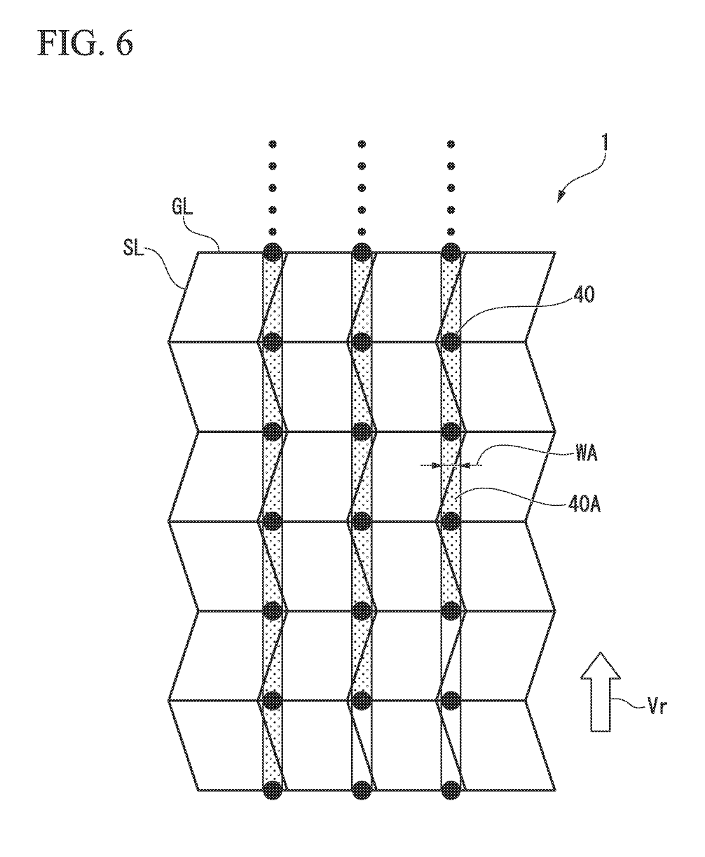

Next, the operating effect of the liquid crystal display device 1 according to the present embodiment will be described, using FIG. 5 and FIG. 6.

FIG. 5 is a plan view describing the operating effect of a liquid crystal display device 1X according to a comparison example.

FIG. 6 is a plan view describing the operating effect of the liquid crystal display device 1 according to the present embodiment.

In FIG. 5 and FIG. 6, as a convenience, of the constituent elements of the liquid crystal display devices, constituent elements other than the source bus lines SL, the gate bus lines GL, and the spacers 40 have been omitted.

In FIG. 5 and FIG. 6, the lower side is the starting edge of rubbing processing (the side at which rubbing processing starts), and the upper side is the ending edge of rubbing processing (the side at which rubbing processing ends).

As shown in FIG. 5, in the liquid crystal display device 1X according to a comparison example, the spacers 40X are disposed along the long sides of the subpixels. In the liquid crystal display device 1X, each of the plurality of spacers 40X is disposed at a position that overlaps with a part of intersection between a source bus lines SL and a gate bus line GL (intersection between the center line of a source bus line SL and the center line of a gate bus line GL).

Given this, because the source bus lines SL bend along each of the sides El of the first subpixel 31 and the sides E2 of the second subpixel 32, the plurality of spacers 40X zig-zag in sawtooth fashion. In this case, if rubbing processing is done by rubbing the orientation film with a cloth after formation of the spacers 40X, because the spacers have a certain height, a region 40AX occurs in an area surrounding the spacers 40X in which rubbing processing is unsufficient. The regions 40AX occur as lines that appear as shadows originating from the spacers 40X toward the rubbing end side.

If such regions 40AX occur in which the rubbing processing is insufficient, the orientation of the liquid crystal molecules might be poor. If this occurs, light leakage or display non-uniformities can occur or the screen can appear to be colored when viewed from an angle.

In the present embodiment as well, as shown in FIG. 6, regions 40A occur in the area surrounding the spacers 40 in which rubbing processing is insufficient. In the present embodiment, however, because the plurality of spacers 40 are disposed linearly in parallel with the rubbing direction Vr, the width WA of the regions 40A in which rubbing processing is insufficient is narrower than the width WAX in the comparison example. It is therefore possible to suppress the occurrence of poor orientation of the liquid crystal molecules, and suppress the occurrence of light leakage, non-uniformities, and the appearance of coloring of the display when viewed at an inclination.

Although in the present embodiment, the description has been of an FFS type liquid crystal display device 1, this is not a restriction. For example, the present invention can also be applied to an IPS type liquid crystal display device.

### Second Embodiment

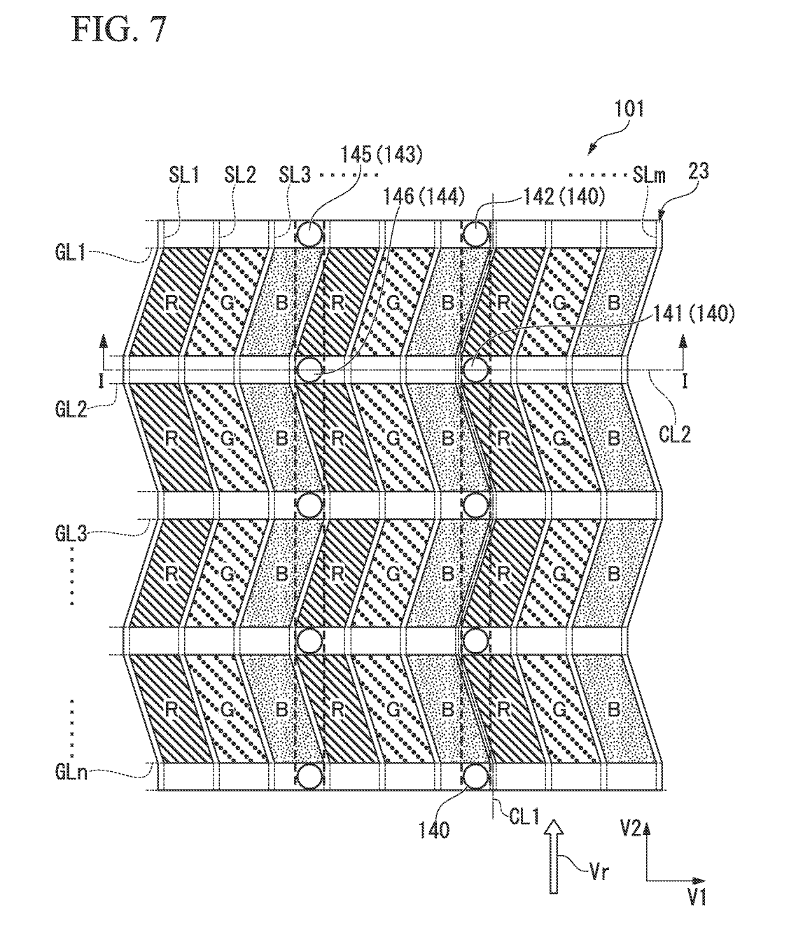

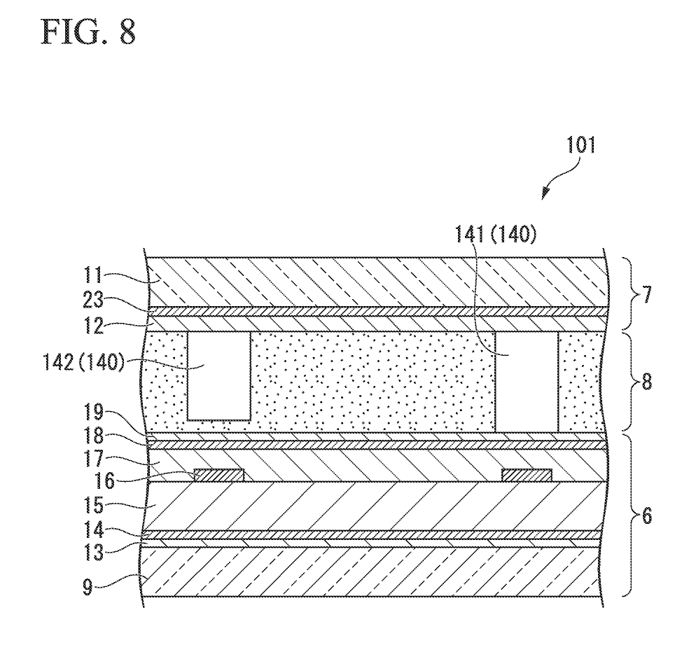

The second embodiment of the present invention will be described using FIG. 7 and FIG. 8.

The basic constitution of a liquid crystal display device 101 according to the present embodiment is the same as the first embodiment, the spacer 140 having a main spacer 141 and a subspacer 142 and the disposition of a plurality of spacers 140 being points of difference with respect to the first embodiment. In the present embodiment, therefore, the description of the basic constitution of the liquid crystal display device 101 will be omitted, and the constitution of the spacer 140 will be described.

FIG. 7 is a plan view describing disposition of spacers 140 according to a second embodiment.

FIG. 7 shows the condition in which a plurality of spacers 140 are disposed on the surface of the orientation film on the opposing substrate 7 side.

In FIG. 7, the reference symbol CL1 indicates the center line of the source bus line SL. The reference symbol CL1 can be said to indicate the center line of the part of the black matrix 23 that overlaps with the source bus line SL. The reference symbol CL2 indicates the center line of the gate bus line GL. The reference symbol CL2 can be said to indicate the center line of the part of the black matrix 23 that overlaps with the gate bus line GL.

As shown in FIG. 7, the plurality of spacers 140 have a plurality of main spacers 141 in contact with both of the pair of substrates and a plurality of subspacers 142 in contact with one substrate of the pair of substrates.

FIG. 8 is a cross-sectional view of the liquid crystal display device 101 along the line I-I in FIG. 7. In FIG. 8, the backlight 2, the polarizing sheet 3, the polarizing sheet 5, and the orientation film and the like shown in FIG. 1 have been omitted as a convenience.

As shown in FIG. 8, the main spacer 141 makes contact with both the TFT array substrate 6 and the opposing substrate 7. The main spacer 141 is a spacer for maintaining the gap between the TFT array substrate 6 and the opposing substrate 7 at a prescribed spacing.

The height of the subspacer 142 is lower than that of the main spacer 141. The subspacer 142 makes contact with the opposing substrate 7 but does not make contact with the TFT array substrate 6. When the liquid crystal display device 101 is pressed from the opposing substrate 7 side, the subspacer 142 makes contact with the TFT array substrate 6. The subspacer 142 is for improving the strength with respect to a pressing force when the liquid crystal display device 101 is pressed from the opposing substrate 7 side.

Returning to FIG. 7, each of the plurality of main spacers 141 is disposed in a position that overlaps with a part of intersection between the plurality of source bus lines (SL1 to SLm) and the plurality of gate bus lines (GL1 to GLn). In contast, each of the subspacers 142 is disposed in a position that does not overlap with a part of intersection between the plurality of source bus lines (SL1 to SLm) and the plurality of gate bus lines (GL1 to GLn). Each of the plurality of subspacers 142 is disposed linearly in parallel with the rubbing direction Vr.

In this case, a part of intersection between the plurality of source bus lines (SL1 to SLm) and the plurality of gate bus lines (GL1 to GLn) means a part of intersection between the center lines CL1 of the plurality of source bus lines (SL1 to SLm) and the center lines CL2 of the plurality of gate bus lines (GL1 to GLn). This will apply as well to the description to follow.

The plurality of subspacers 142 have a first subspacer group 145 constituted by a plurality of first subspacers 143 disposed on one side (left side; blue subpixel 30B side) in the first direction V1 with respect to the each of the plurality of source bus lines (SL1 to SLm) and a second subspacer group 146 constituted by a plurality of second subspacers 144 disposed on the other, opposing side (right side; red subpixel 30R side) with respect to the each of the plurality of source bus lines (SL1 to SLm).

In the present embodiment, the first subspacer group 145 and the second subspacer group 146 are disposed alternately in the second direction V2. This creates a constitution in which the plurality of subspacers 142 are disposed linearly in parallel with the rubbing direction Vr.

However, each of the first subspacer group 145 and the second subspacer group 146 has parts in which a first subspacer 143 and a second subspacer 144 are not disposed (a part in which the subspacer 142 is not disposed). In the part in which a subspacer 142 is not disposed, a main spacer 141 is disposed at a position that overlaps a part of intersection between a source bus line SL and a gate bus line GL. That is, overall, the constitution is one in which a plurality of spacers 140 are disposed substantially linearly in parallel with the rubbing direction Vr.

In this case substantially linearly includes the condition in which, if two spacers disposed at neighboring positions along the source bus line SL are SP1 and SP2, the distance J between the center of SP1 and the center of SP2 in a direction along the gate bus line GL is smaller than K cos γ (J<K cos γ).

In the present embodiment, although the width of the main spacer in a direction along the gate bus line GL and the width of the subspacer in a direction along the gate bus line GL are substantially equal, it is desirable that the diameter of the main spacer be smaller than the diameter of the subspacer and also that the main spacer be disposed within the width of the subspacer along the gate bus line. This causes the plurality of spacers to be disposed linearly in parallel with the rubbing direction Vr.

In the liquid crystal display device 101 of the present embodiment as well, it is possible to suppress the occurrence of poor orientation of the liquid crystal molecules, and suppress the occurrence of light leakage, non-uniformities, and the appearance of coloring of the screen when viewed at an inclination. Additionally, according to the present embodiment, it is possible to improve the strength with respect to a pressing force, while maintaining uniformity of thickness of the liquid crystal cell over the entire liquid crystal display device.

In the present embodiment, although the main spacer 141 is disposed at a position of a part of overlapping between the source bus line SL and the gate bus line GL, this is not a restriction. For example, the main spacer 141 may be disposed at a position of a part at which the source bus line SL and the gate bus line GL do not overlap (a position at which the subspacer 142 is disposed). This achieves a constitution in which the plurality of spacers 140 are disposed linearly in parallel with the rubbing direction Vr. However, from the standpoint of maintaining uniformity of thickness of the liquid crystal cell over the entire liquid crystal display device, it is desirable that the main spacer 141 be disposed at a position overlapping a part at which the source bus line SL and the gate bus line GL intersect.

### Third Embodiment

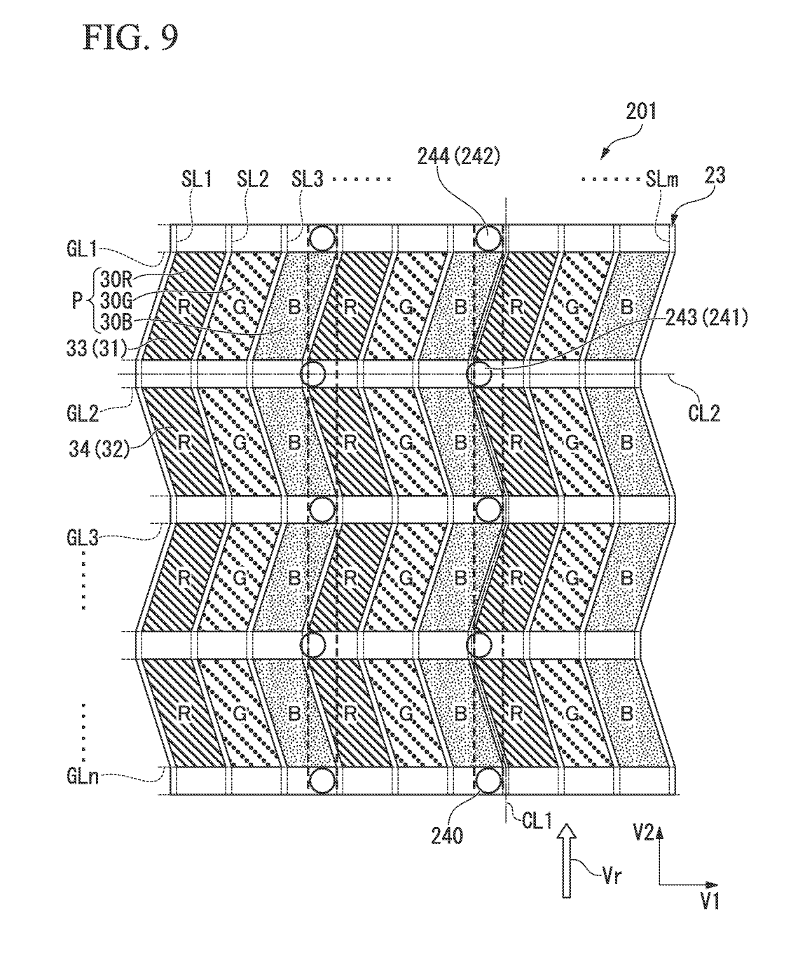

The second embodiment of the present invention will be described using FIG. 9.

The basic constitution of a liquid crystal display device 201 according to the present embodiment is the same as the first embodiment, and a plurality of spacers 240 having a third spacer 241 and a fourth spacer 242 and disposition of a plurality of spacer 240 are points of difference with respect to the first embodiment. In the present embodiment, therefore, the description of the basic constitution of the liquid crystal display device 201 will be omitted, and the constitution of the spacer 240 will be described.

FIG. 9 is a plan view describing the disposition of the spacers 240 according to the third embodiment.

FIG. 9 shows the disposition of a plurality of spacers 240 on the surface of the orientation film on the opposing substrate 7 side.

In FIG. 9, the reference symbol CL1 indicates the center line of the source bus line SL. The reference symbol CL1 can also be said to indicate the center of the part of the black matrix 23 that overlaps with the source bus line SL. The reference symbol CL2 indicates the center line of the gate bus line GL. The reference symbol CL2 can also be said to indicate the center of the part of the black matrix 23 that overlaps with the gate bus line GL.

As shown in FIG. 9, the plurality of spacers 240 has a third spacer group 243 constituted by a plurality of third spacers 241 disposed at positions overlapping parts of intersection between the plurality of source bus lines (SL1 to SLm) and the plurality of gate bus lines (GL1 to GLn) and a fourth spacer group 244 constituted by a plurality of fourth spacers 242 disposed at positions not overlapping parts of intersection between the plurality of source bus lines (SL1 to SLm) and the plurality of gate bus lines (GL1 to GLn).

Each of the first subpixel group 33 and the second subpixel group 34 has a plurality of red subpixels 30R and a plurality of blue subpixels 30B disposed so as to be mutually neighboring.

In the present embodiment, the third spacer group 243 and the fourth spacer group 244 are disposed alternately in the second direction V2. Specifically, each of the plurality of fourth spacers 242 is disposed more toward the blue subpixel 30B side than the boundary part between the red subpixel 30R and the blue subpixel 30B (the region in which the black matrix 23 is formed between the red subpixel 30R and the blue subpixel 30B). This achieves a constitution in which a region in which rubbing processing is insufficient occurs on the blue subpixel 30B side.

In the liquid crystal display device 201 of the present embodiment as well, it is possible to suppress the occurrence of poor orientation of the liquid crystal molecules, and suppress the occurrence of light leakage, non-uniformities, and the appearance of coloring of the screen when viewed at an inclination. Additionally, because blue light leakage and coloring are less noticeable than red, the present embodiment makes it difficult to notice light leakage and coloring.

In the present embodiment, although each of the plurality of fourth spacers is disposed more toward the blue subpixel 30B side than the boundary part between the red subpixel 30R and the blue subpixel 30B, this is not a restriction. For example, each of the plurality of fourth spacers may be disposed more toward the red subpixel 30R side than the boundary part between the red subpixel 30R and the blue subpixel 30B. However, from the standpoint of making light leakage and coloring less noticeable, it is desirable that each of the plurality of fourth spacers be disposed more toward the blue subpixel 30B side than the boundary part between the red subpixel 30R and the blue subpixel 30B.

Additionally, each of the plurality of fourth spacers may be disposed between subpixels of other colors, such as between the green subpixel 30G and the blue subpixel 30B.

Although preferred embodiments of the present invention have been described with references made to the drawings, it is obvious that the present invention is not restricted to the above-noted embodiments. The various shapes and combinations of the above-noted constituent elements and members shown in the foregoing embodiments are merely exemplary, and can be subjected to various modifications, based on design requirements, within the scope of the spirit of the present invention.

Additionally, specific descriptions relating the shapes, numbers, dispositions, forming methods, and the like are not restricted to the above embodiments, and it is possible to change them appropriately.

### INDUSTRIAL APPLICABILITY

The present invention can be used in a liquid crystal display device.

### DESCRIPTION OF REFERENCE SYMBOLS

1, 101, 202 . . . Liquid crystal display device, 6 . . . TFT array substrate, 7 . . . Opposing substrate, 8 . . . Liquid crystal layer, 21a . . . First strip electrode, 22a . . . Second strip electrode, 30 . . . Subpixel, 30R . . . Red subpixel, 30B . . . Blue subpixel, 31 . . . First subpixel, 33 . . . First subpixel group, 32 . . . Second subpixel, 34 . . . Second subpixel group, 40, 140, 240 . . . Spacer, 41 . . . First spacer, 42 . . . Second spacer, 43 . . . First spacer group, 44 . . . Second spacer group, 141 . . . Main spacer, 142 . . . Subspacer, 241 . . . Third spacer, 242 . . . Fourth spacer, 243 . . . Third spacer group, 244. . . Fourth spacer group, V1 . . . First direction, V2 . . . Second direction, Vr . . . Rubbing direction, SL . . . Source bus line, GL . . . Gate bus line, E1 . . . Side of the four sides of the first subpixel intersecting with the first direction, E2 . . . side of the four side of the first subpixel that neighbors to a side intersecting with the first direction

1. A liquid crystal display device in which a plurality of spacers are disposed between a pair of substrates and a liquid crystal is disposed in a gap between the pair of substrate maintained by the plurality of spacers, the liquid crystal display device comprising:
a plurality of source bus lines disposed to be mutually neighboring;
a plurality of gate lines disposed to be mutually neighboring and intersecting with the plurality of source lines;
a first subpixel group comprising a plurality of first subpixels, and
a second subpixel group comprising a plurality of second subpixels;
wherein the first and second subpixel groups are disposed alternately in a direction orthogonal to the gate bus line,
each of the plurality of first subpixels comprises a plurality of first strip electrodes comprising a part inclined by an angle of α (0°<α<90°) clockwise with respect to a rubbing direction,
each of the plurality of second subpixels comprises a plurality of second strip electrodes comprising a part inclined by an angle of α (0°<α<90°) counterclockwise with respect to the rubbing direction,
each of the plurality of source bus lines comprises a first inclined part inclined by an angle of β (0°<β<90°) clockwise with respect to the rubbing direction and also extending along an edge of the first subpixel and a second inclined part inclined by an angle of β (0°<β<90°) counterclockwise with respect to the rubbing direction and also extending along an edge of the second subpixel,
the rubbing direction is orthogonal to the gate bus line,
each of the plurality of spacers is disposed in a vicinity of the source bus line and also disposed linearly in parallel with the rubbing direction,
each of the plurality of spacers is disposed at a position that overlaps each of the plurality of gate bus lines, and
each of the plurality of spacers is disposed at a position that does not overlap a part of intersection between the plurality of source bus lines and gate bus lines.

2-3. (canceled)

4. The liquid crystal display device according to claim 1, wherein the plurality of spacers comprises a first spacer group comprising a plurality of first spacers disposed on one side in a direction parallel to the gate bus line with respect to each of the plurality of source bus lines; and
a second spacer group comprising a plurality of second spacers disposed on another side opposite from the one side with respect to each of the plurality of source bus lines, and
wherein the first spacer group and the second spacer group are disposed alternately in a direction orthogonal to the gate bus line.

5. The liquid crystal display device according to claim 1, wherein the plurality of spacers comprises a plurality of main spacers that make contact with both of the pair of substrates and a plurality of subspacers that make contact with one of the pair of substrates, and
wherein, of the plurality of spacers, at least each of the plurality of subspacers is disposed linearly in parallel with the rubbing direction.

6. The liquid crystal display device according to claim 1, wherein the plurality of spacers comprises a third spacer group comprising a plurality of third spacers disposed at positions overlapping parts of intersection between the plurality of source bus lines and the plurality of gate bus lines and a fourth spacer group comprising a plurality of fourth spacers disposed at positions not overlapping parts of intersection between the plurality of source bus lines and the plurality of gate bus lines, and wherein
the third spacer group and the fourth spacer group are disposed alternately in a direction orthogonal to the gate bus lines.

7. The liquid crystal display device according to claim 6, wherein
each of the first subpixel group and the second subpixel group comprises a plurality of red subpixels and a plurality of blue subpixels disposed to be mutually neighboring, and
each of the plurality of fourth spacers is disposed more toward the blue subpixel side than the boundary part between the red subpixel and the blue subpixel.

8. The liquid crystal display device according to claim 1, wherein the first subpixel and the second subpixel comprise shapes axially symmetric about a symmetry axis parallel to the gate bus line.

9. The liquid crystal display device according to claim 1, wherein
at an undriven time, in a case that a drive signal is not supplied to the plurality of first strip electrodes, the orientation direction of the liquid crystal layer coincides with the rubbing direction, and at a driven time, in a case that a drive signal is supplied to the plurality of first strip electrodes, the orientation direction of the liquid crystal layer coincides with the direction of arrangement of the plurality of first strip electrodes, and wherein
at an undriven time, in a case that a drive signal is not supplied to the plurality of second strip electrodes, the orientation direction of the liquid crystal layer coincides with the rubbing direction, and at a driven time, in a case that a drive signal is supplied to the plurality of second strip electrodes, the orientation direction of the liquid crystal layer coincides with the direction of arrangement of the plurality of second strip electrodes.
